(19) United States
(12) Patent Application Publication
(10) Pub. No.: US 2013/0060175 A1
(43) Pub. Date: Mar. 7, 2013

(54) ROTATING & TAPPING TYPE MASSAGE DEVICE

(71) Applicant: Jui Yao Chen, Changhua County (TW)

(72) Inventor: Jui Yao Chen, Changhua County (TW)

(21) Appl. No.: 13/226,424

(22) Filed: Sep. 6, 2011

(51) Int. Cl. A61H 23/00

(52) U.S. Cl. 601/108

(57) ABSTRACT

A rotating & tapping type massage device comprises: a base, a drive motor, a drive gear assembly, a driven member, a push member, a driven shaft and a massage member. The drive motor rotates the drive gear assembly, the drive gear assembly rotates the driven member, and then the drive member pushes the push member when rotating. The driven member is provided with skew teeth to be engaged with skew concaves formed on the push member. When the driven member rotates in different directions, it can selectively cause rotation or repeated up and down displacement of the push member, and meanwhile, the push member drives the driven shaft to move and makes the massage member disposed on the driven shaft rotate or move up and down repeatedly, so that the massage member can selectively massage in a rotation or tapping manner.

### BACKGROUND OF THE INVENTION

1. Field of the Invention

The present invention relates to a massage device, and more particularly to a rotating & tapping type massage device capable of massaging in a rotating or tapping fashion.

2. Description of the Prior Art

Today, people are living under great pressure and therefore need to release stress by using some massage devices, and massages devices are generally divided into rotary type (with a rotary head) and vibration type. Some users would like to use the massage device to massage points; however, point massage requires the massage device to have relatively big massage force.

The present invention has arisen to mitigate and/or obviate the afore-described disadvantages.

### SUMMARY OF THE INVENTION

The primary object of the present invention is to provide a rotating & tapping type massage device which is capable of massaging in a rotating or tapping fashion.

A rotating & tapping type massage device in accordance with the present invention comprises: a base, a drive motor, a drive gear assembly, a driven member, a push member, a driven shaft and a massage member.

The drive motor rotates the drive gear assembly, the drive gear assembly rotates the driven member, and then the drive member pushes the push member when rotating. The driven member is provided with skew teeth to be engaged with skew concaves formed on the push member. When the driven member rotates in different directions, it can selectively cause rotation or repeated up and down displacement of the push member, and meanwhile, the push member drives the driven shaft to move and makes the massage member disposed on the driven shaft rotate or move up and down repeatedly, so that the massage member can selectively massage in a rotation or tapping manner.

### BRIEF DESCRIPTION OF THE DRAWINGS

FIG. 1 is an exploded view of a rotating & tapping type massage device in accordance with the present invention;

FIG. 2 is an assembly view of the rotating & tapping type massage device in accordance with the present invention;

FIG. 3 is a perspective view showing a part of the rotating & tapping type massage device in accordance with the present invention;

FIG. 4A is a cross sectional assembly view of the rotating & tapping type massage device in accordance with the present invention;

FIG. 4B is a magnifying view of a part of FIG. 4A;

FIG. 5A is another cross sectional assembly view of the rotating & tapping type massage device in accordance with the present invention;

FIG. 5B is a magnifying view of a part of FIG. 5A;

FIG. 6 is an exploded view of a second embodiment of the rotating & tapping type massage device in accordance with the present invention; and

FIG. 7 is an exploded view of a third embodiment of the rotating & tapping type massage device in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

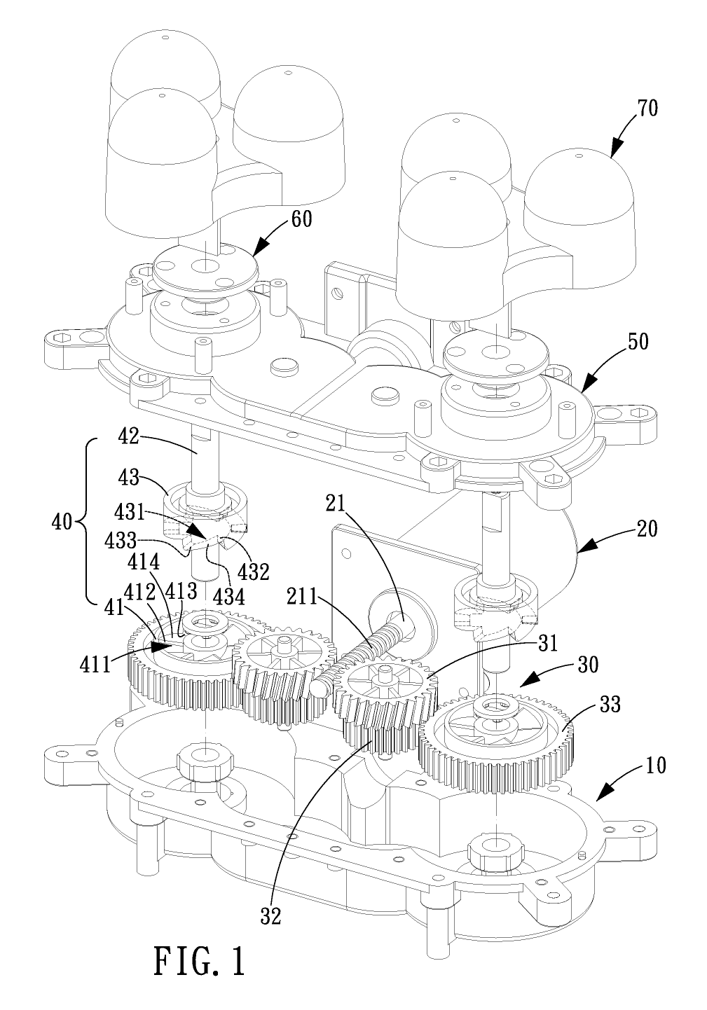

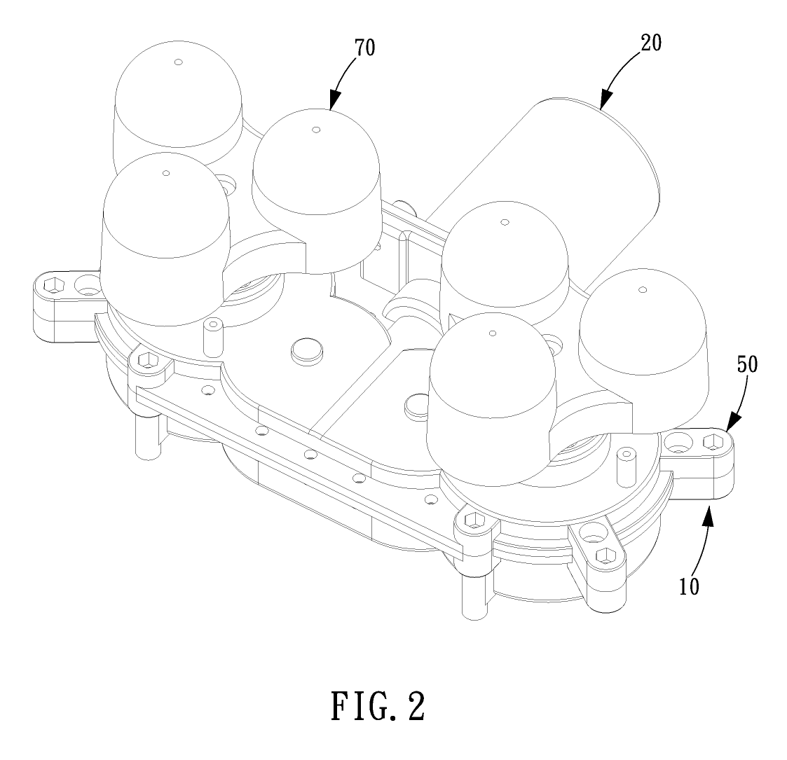

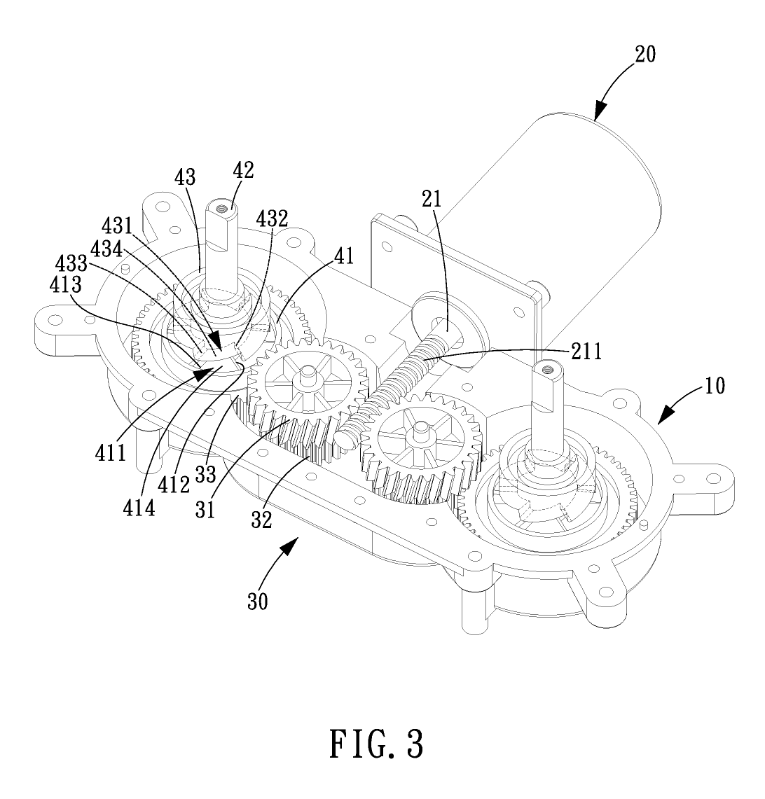

Referring to FIGS. 1-5, a rotating & tapping type massage device in accordance with the present invention comprises: a base 10, a drive motor 20, two drive gear assemblies 30, two driven assemblies 40, a cover 50, two sleeves 60 and at least one massage member 70.

The drive motor 20 includes a drive shaft 21 formed with an outer thread 211, the drive shaft 21 is inserted in the base 10.

The two drive gear assemblies 30 are received in the base 10 and each include a drive toothed wheel 31, a mid toothed wheel 32 and a driven toothed wheel 33. The drive toothed wheel 31 and the mid toothed wheel 32 are connected to each other and move together. The two drive gear assemblies 30 are located both sides of the drive shaft 21 and are engaged with and driven by the outer thread 211 of the drive shaft 21, and then the driven toothed wheel 33 is engaged with and rotated by the mid toothed wheel 32, so that the drive gear assemblies 30 are rotated by the drive motor 20 through the engagement with the outer thread 211.

The two driven assemblies 40 each include a driven member 41, a driven shaft 42 and a push member 43.

The driven member 41 is disposed on one side of the driven toothed wheel 33 and rotates together with the driven toothed wheel 33, and around the center of one surface of the driven member 41 are formed a plurality of skew teeth 411. Each of the skew teeth 411 includes a high point 412, a low point 413 and a skew surface 414 connected between the high and low points 412, 413 in such a manner that the skew surface 414 gradually decreases clockwise in height from the high point 412 towards the low point 413, and the high point 412 of one skew tooth 411 is adjacent to the low point 413 of a neighboring tooth 411.

The push members 43 are sleeved on the driven shafts 42 which each have one end inserted in the driven toothed wheel 33, and around the centre of one surface of the push member 43 are formed a plurality of skew concaves 431. Each of the skew concaves 431 includes a low point 432, a high point 433 and a skew surface 434 connected between the low and high points 432, 433 in such a manner that the skew surface 434 gradually decreases clockwise in height from the high point 433 towards the low point 432, and the high point 433 of one skew concave 431 is adjacent to the low point 432 of a neighboring skew concave 431.

The skew concaves 431 of the push member 43 are engaged with the skew teeth 411 of the driven member 41.

The cover 50 covers the base 10, and the driven shafts 42 have another ends extended out of the cover 50.

The two sleeves 60 are sleeved on the driven shafts 42 and located between the driven shafts 42 and the cover 50.

There are two massage members 70 in this embodiment, and the massage members 70 are engaged on the ends of the two driven shafts 42 extending out of the cover 50 and move together with the driven shafts 42.

When in use, the drive motor 20 rotates the drive shaft 21, then the drive gear assemblies 30 are rotated by the outer thread 211 of the drive shaft 21 in such a manner that the drive toothed wheel 31 is rotated by the drive shaft 21 to cause the rotation of the mid toothed wheel 32, and the mid toothed wheel 32 rotates the driven toothed wheel 33, which finally causes the rotation of the driven member 41.

When the driven toothed wheel 33 drives the driven member 41 to rotate in counterclockwise direction, the skew teeth 411 of the driven member 41 will be engaged in the skew concaves 431 of the push member 43 in such a manner that the skew surface 414 of the skew teeth 411 is pressed against the skew surface 434 of the skew concaves 431, and the high point 412 of the skew teeth 411 is abutted against the low point 432 of the skew concaves 431, so that the driven toothed wheel 33 and the driven member 41 are engaged with each other. When the driven toothed wheel 33 continues rotating, the push member 43 will be rotated to cause the rotation of the driven shaft 42, and finally the driven shaft 42 drives the massage member 70 to rotate, thus providing a rotating type massage action.

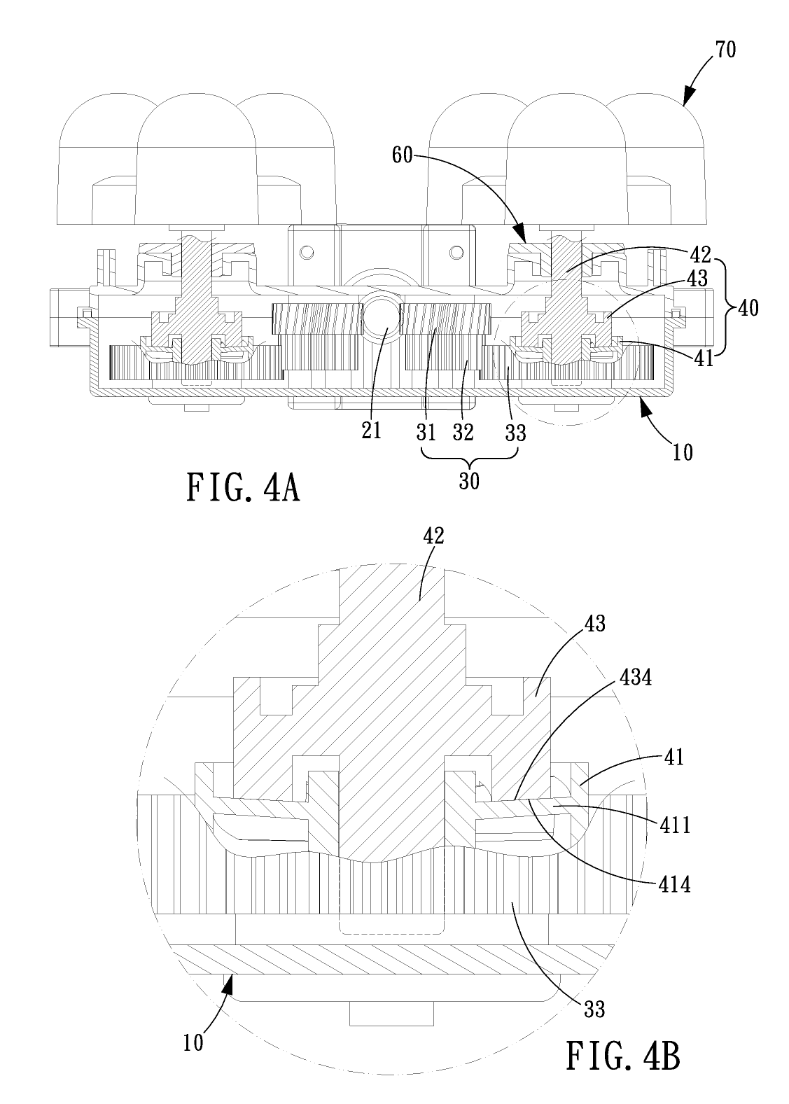

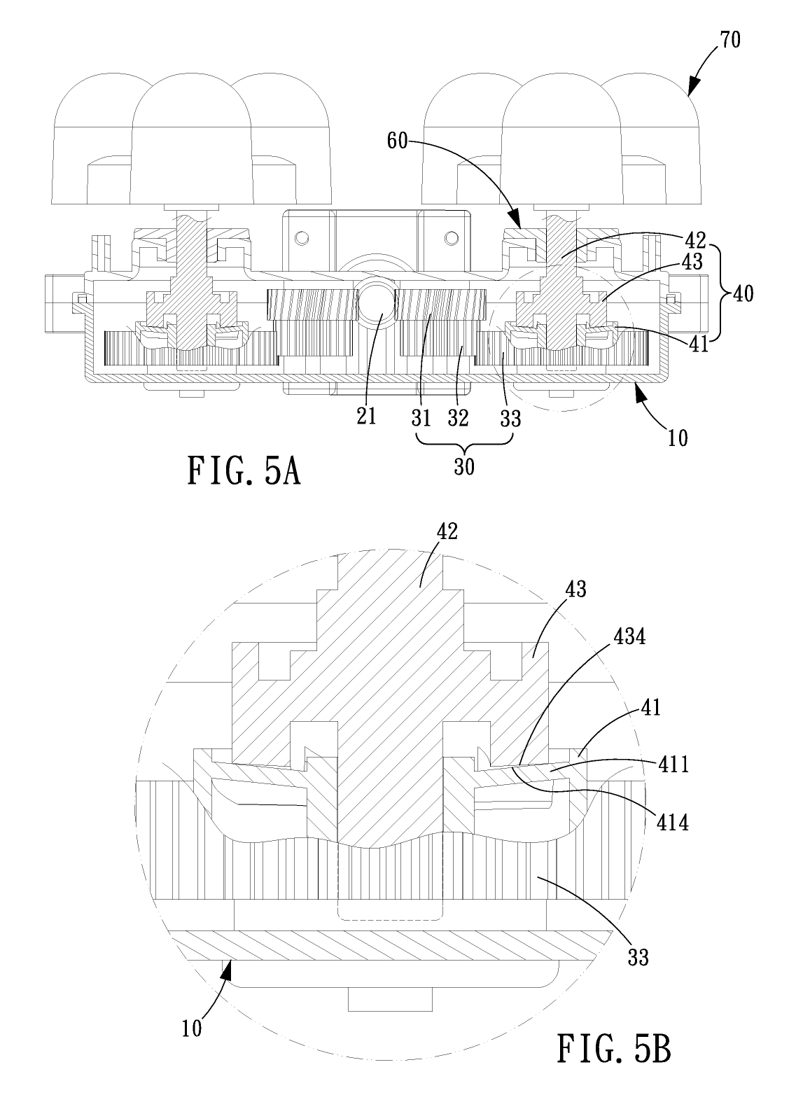

When the driven toothed wheel 33 drives the driven member 41 to rotate in clockwise direction, the skew surface 414 of the driven member 41 will be moved along the skew surface 434 of the push member 43. The high point 412 and the low point 432 of the driven member 41 are initially received at the low point 432 and the high point 433 of the skew concaves 431, respectively, so that the skew teeth 411 are fully engaged with and pressed against the skew concaves 431. When the driven member 41 continues rotating, and the high point 412 of the skew teeth 411 keeps moving towards the high point 433 of the skew concaves 431, the skew teeth 411 will begin to push the push member 43 to move upward, and thus the continuous rotation of the driven member 41 will make the driven member 41 to move up and down repeatedly, as shown in FIGS. 4-5, causing tapping action of the massage member 70.

With the cooperation of the skew teeth 411 of the driven member 41 and the skew concaves 431 of the push member 43, the drive motor 20 can rotate to make the massage member massage in a rotating or tapping manner to meet different demands. The number of the massage member 70 can also be only one, and the number and positions of the drive gear assemblies 30 can also be adjusted as long as the drive gear assemblies 30 can be engaged with the outer thread 211 of the drive shaft 21 of the drive motor 20 to move the driven members 41.

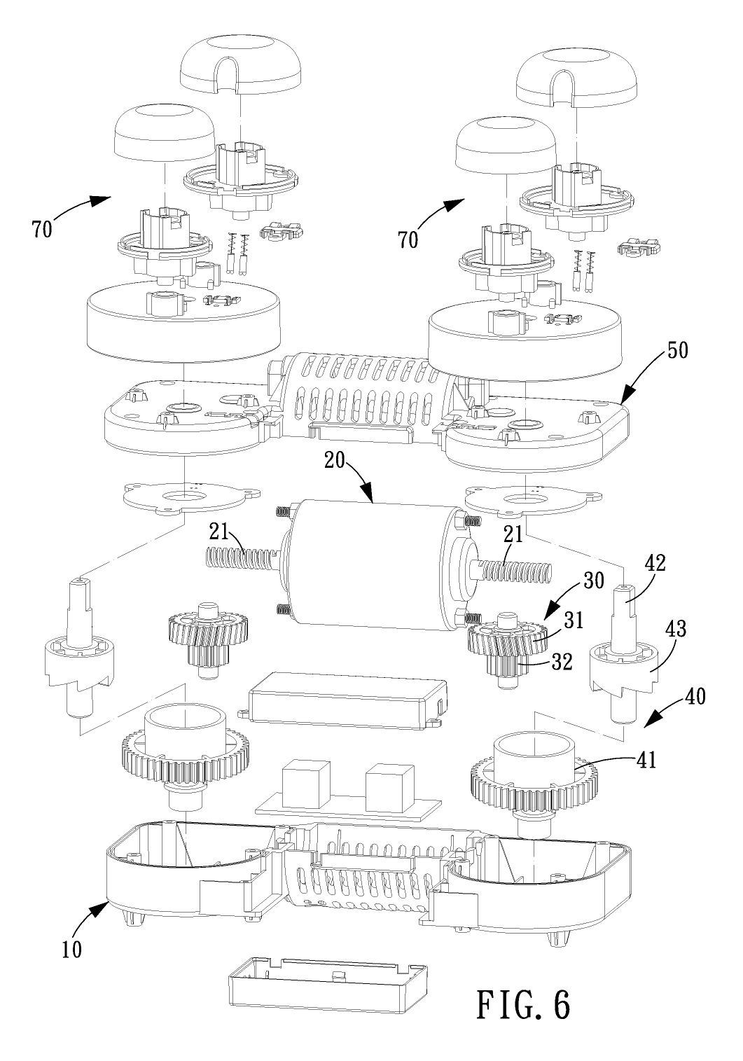

Referring then to FIG. 6, another embodiment of the present invention is shown, wherein the drive motor 20 is directly disposed in the base 10, and both ends of the drive shaft 21 extend out of the drive motor 20 to engage with a drive gear assembly 30, respectively. Then the drive gear assemblies 30 are engaged with two driven assemblies 40 in such a manner that the driven shaft 42 of the respective driven assemblies 40 extends out of the cover 50 to connect a massage member 70.

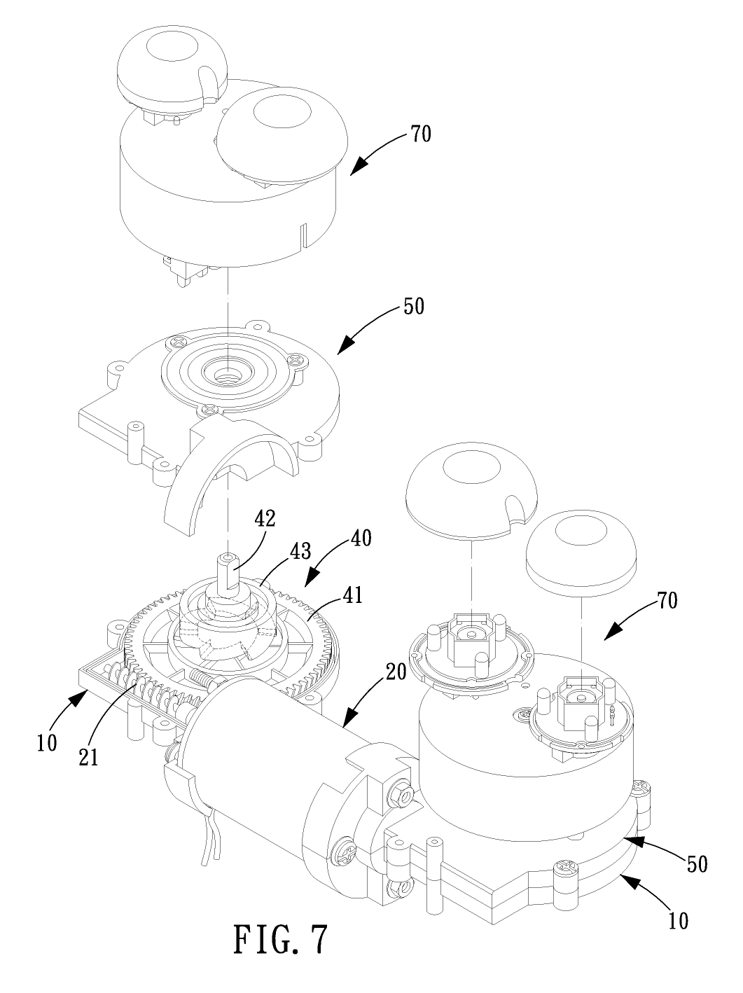

Referring finally to FIG. 7, a third embodiment of the present invention is shown, wherein the drive motor 20 is directly disposed on the base 10, and both ends of the drive shaft 21 extend out of the drive motor 20 to engage with a driven assembly 40, respectively in such a manner that the driven shaft 42 of the respective driven assemblies 40 extends out of the cover 50 to connect a massage member 70.

While we have shown and described various embodiments in accordance with the present invention, it is clear to those skilled in the art that further embodiments may be made without departing from the scope of the present invention.

What is claimed is:

1. A rotating & tapping type massage device comprising:
a base;
a drive motor including a drive shaft formed with an outer thread, the drive shaft being inserted in the base;
a drive gear assembly received in the base and engaged with and rotated by the outer thread of the drive shaft of the drive motor;
a driven member connected and driven by the drive gear assembly, and around a center of one surface of the driven member being formed a plurality of skew teeth, each of the skew teeth including a high point, a low point and a skew surface connected between the high and low points, the skew teeth being arranged in such a manner that the high point of one skew tooth 411 is adjacent to the lower point of another neighboring tooth;
a push member sleeved on the driven shaft which has one end inserted in the driven toothed wheel, and around a centre of one surface of the push member being formed a plurality of skew concaves, each of the skew concaves includes a low point, a high point and a skew surface connected therebetween, and the skew concaves being arranged in such a manner the high point of one skew concave is adjacent to the lower point of another neighboring concave, and the skew concaves of the push member are engaged with the skew teeth of the push member; and
a two massage member engaged on another end of the driven shaft.

2. The rotating & tapping type massage device as claimed in claim 1 further comprising a cover to cover the base, and the another end of the driven shaft extends out of the cover.

3. The rotating & tapping type massage device as claimed in claim 2 further comprises a sleeve sleeved on the driven shaft and located between the driven shaft and the cover.

4. The rotating & tapping type massage device as claimed in claim 1, wherein the drive gear assembly includes a drive toothed wheel, a mid toothed wheel and a driven toothed wheel, the drive toothed wheel and the mid toothed wheel are connected to each other and move together, the drive gear assemblies is engaged with and driven by the outer thread of the drive shaft, and then the driven toothed wheel is engaged with and rotated by the driven toothed wheel, the driven member is disposed on one side of the driven toothed wheel and rotates together with the driven toothed wheel.

5. The rotating & tapping type massage device as claimed in claim 1, wherein the skew surface of each of the skew teeth gradually decreases clockwise in height from the high point towards the low point of the each of the skew teeth, and the skew surface of each of the skew concaves gradually decreases clockwise in height from the high point towards the low point of the each of the skew concaves.
